(19) United States
(12) Patent Application Publication
(10) Pub. No.: US 2024/0357683 A1
(43) Pub. Date: Oct. 24, 2024

(54) Proactive Measurement Procedures for RRC Re-Establishment in NB-IoT

(71) Applicant: Telefonaktiebolaget LM Ericsson (publ), Stockholm (SE)

(72) Inventors: Santhan Thangarasa, Vällingby (SE); Muhammad Ali Kazmi, Sundbyberg (SE)

(21) Appl. No.: 18/700,090

(22) PCT Filed: Oct. 21, 2022
(86) PCT No.: PCT/SE2022/050954

§ 371 Date: Apr. 10, 2024

Related U.S. Application Data
(60) Provisional application No. 63/270,194, filed on Oct. 21, 2021.

(51) Int. Cl. H04W 76/19; H04W 24/08

(52) U.S. Cl. CPC H04W 76/19; H04W 24/08

(57) ABSTRACT

Upon detecting a triggering condition (e.g., a transition between RRC states, a radio link problem (RLP), etc.), a UE determines a first carrier frequency (F1) of serving cell (Cell1) and a second carrier frequency (F2) of a second cell (Cell2), are different, and selects a measurement procedures to measure on Cell2. The UE is configured with F2 by the network node for performing the RRC connection re-establishment procedure, e.g., when RLP is detected. The UE measures on Cell2 based on a measurement procedure in which the measurement occasions are limited to specific occasions, where at least a certain number of reference signals are guaranteed. The measurement procedure used for performing measurement on Cell2 may further depend on the measurement triggering condition. The UE may further determine the time instance when the UE initiates measurements on Cell2 based on the triggering condition.

### RELATED APPLICATIONS

This application claims priority to U.S. Provisional patent Application Ser. No. 63/270,194 filed Oct. 21, 2021, the entire contents of which are incorporated herein by reference.

### TECHNICAL FIELD

The present invention relates generally to wireless communication networks, and in particular to measurement procedures by NarrowBand Internet of Things (NB-IoT) terminals to re-establish Radio Resource Control connection.

### BACKGROUND

Wireless communication networks are ubiquitous in many parts of the world. These networks continue to grow in capacity and sophistication. To accommodate more users, different types of devices, and different use cases, the technical standards governing the operation of wireless communication networks continue to evolve. The fourth generation (4G) of network standards has been deployed, and the fifth generation (5G, also referred to as New Radio or NR) is in development. 5G is not yet fully defined, but in an advanced draft stage within the Third Generation Partnership Project (3GPP). 5G wireless access will be realized by the evolution of Long Term Evolution (LTE) for existing spectrum, in combination with new radio access technologies that primarily target new spectrum. Thus, it includes work on a 5G New Radio (NR) Access Technology, also known as next generation (NX). The NR air interface targets spectrum in the range from below 1 GHz up to 100 GHZ, with initial deployments expected in frequency bands not utilized by LTE. Some LTE terminology may be used in this disclosure in a forward looking sense, to include equivalent 5G entities or functionalities, although a different term is or may eventually be specified in 5G.

In addition to expanded bandwidth and higher bitrates to enrich User Equipment (UE) experience, the 5G NR technology will include expanded support for machine-to-machine (M2M) or machine type communications (MTC), variously known as the Networked Society or Internet of Things (IoT). This support focuses on optimized network architecture and improved indoor coverage for a massive number of wireless devices with the following characteristics: low throughput (e.g., 2 kbps); low delay sensitivity (˜10 seconds); ultra-low device cost (below 5 dollars); and low device power consumption (battery life of 10 years).

In Release 13, 3GPP standardized two different approaches to MTC. Enhanced MTC (eMTC), also known as Long Term Evolution-Machine-to-machine (LTE-M), includes cost reduction measures such as lower bandwidth, lower data rates, and reduced transmit power, as compared to legacy (broadband) LTE. Narrowband Internet of Things (NB-IoT) more aggressively addresses the extremely low cost market with less than 200 KHz of spectrum and flexibility to deploy concurrently with legacy networks or outside of active legacy spectrum. NB-IoT targets improved indoor coverage, support for massive numbers of low throughput devices, low delay sensitivity, ultra-low device cost, and low device power consumption.

As used herein, the term “wireless device” includes both UEs, such as cellphones and smartphones, and M2M/MTC/IoT type devices, which are often embedded in meters, appliances, vehicles, and the like, and are not directly controlled by users.

### NB-IoT Deployment Modes

NB-IoT supports three different deployment scenarios, or modes of operation:

“Stand-alone operation” utilizes, for example, spectrum currently being used by GSM EDGE Radio Access Network (GERAN) systems as a replacement of one or more GSM carriers. In principle, it operates on any carrier frequency which is neither within the carrier of another system nor within the guard band of another system's operating carrier. The other system can be another NB-IoT operation or any other RAT, e.g., LTE.

“Guard band operation” utilizes the unused resource blocks within an LTE carrier's guard-band. The term guard band may also interchangeably be referred to as guard bandwidth. As an example, in the case of an LTE bandwidth (BW) of 20 MHZ (i.e., Bw1=20 MHz or 100 Resource Blocks, or RBs), the guard band operation of NB-IoT can be placed anywhere outside the central 18 MHz, but within 20 MHz LTE BW.

“In-band operation” utilizes resource blocks within a normal LTE carrier. The in-band operation may also interchangeably be referred to as in-bandwidth operation. More generally, the operation of one RAT within the BW of another RAT is also referred to as in-band operation. As an example, in an LTE BW of 50 RBs (i.e., Bw1=10 MHz or 50 RBs), NB-IoT operation over one resource block (RB) within the 50 RBs is called in-band operation.

### Anchor Carrier and Non-Anchor Carrier in NB-IoT

In NB-IoT, both anchor and non-anchor carriers are defined. In an anchor carrier, the UE assumes that anchor-specific signals are transmitted on the downlink (DL). These include, e.g., Narrowband Primary/Secondary Synchronization Signal (NPSS/NSSS), Narrowband Physical Broadcast Channel (NPBCH), and System Information Block-Narrowband (SIB-NB). In a non-anchor carrier, the UE does not assume that NPSS/NSSS/NPBCH/SIB-NB are transmitted on DL. The anchor carrier is transmitted on at least subframes #0, #4, #5 in every frame, and subframe #9 in every other frame. Additional DL subframes in a frame can also be configured on an anchor carrier by means of a DL bit map. The anchor carriers transmitting NPBCH/SIB-NB also contain the Narrowband Reference Signal (NRS). The non-anchor carrier contains NRS during certain occasions, and UE-specific signals such as Narrowband Physical Downlink Control/Shared Channels (NPDCCH/NPDSCH). NRS, NPDCCH and NPDSCH are also transmitted on the anchor carrier. The resources for non-anchor carriers are configured by the network node. The non-anchor carrier can be transmitted in any subframe, as indicated by a DL bit map. For example, the LTE base station, known as enhanced Node-B (eNB), signals a DL bit map of DL subframes which are configured as a non-anchor carrier using a Radio Resource Control (RRC) message (DL-Bitmap-NB). The anchor carrier and/or non-anchor carrier are typically operated by the same network node, e.g., by the serving cell. However, the anchor carrier and/or non-anchor carrier may also be operated by different network nodes.

### RLM Procedure in NB-IoT

The purpose of Radio Link Monitoring (RLM) is to monitor the radio link quality of the serving cell of the UE, and use that information to decide whether the UE is in in-sync or out-of-sync with respect to that serving cell. In LTE RLM is carried out by UE performing measurements on downlink cell-specific reference symbols (CRS) in RRC_CONNECTED state. If results of radio link monitoring indicate a number of consecutive out of sync (OOS) indications, then the UE starts a Radio Link Failure (RLF) procedure, and declares RLF after the expiry of an RLF timer (e.g., T310). The actual procedure is carried out by comparing the estimated downlink reference symbol measurements to some thresholds, Qout and Qin. Qout and Qin correspond to the Block Error Rate (BLER) of a hypothetical control channel (e.g., NPDCCH) transmissions from the serving cell. Examples of the target BLER corresponding to Qout and Qin are 10% and 2%, respectively. The radio link quality assessment in RLM is performed based on a reference signal (e.g., NRS), at least once every radio frame (when not configured with Discontinuous Reception, or DRX) or periodically with a DRX cycle (when configured with DRX), over the system bandwidth or control channel bandwidth (e.g., NPDCCH BW) for the UE, or over the UE bandwidth (e.g., 200 kHz).

T310 is also referred to as the RLF timer, which starts when the UE detects physical layer problems for the Primary Cell (PCell). More specifically, the RLF timer starts upon the UE receiving N310 number of consecutive out-of-sync indications from its lower layers. When T310 expires, then the RLF is declared. However, T310 is reset upon the UE receiving N311 number of consecutive in-sync indications from its lower layers. Upon RLF declaration (i.e., T310 expiration) the UE starts an RRC connection re-establishment procedure, and starts another timer T311. During the RRC connection re-establishment procedure, the UE identifies a cell on any carrier configured for RRC connection re-establishment. The UE re-establishes the RRC connection to the identified cell, e.g., by sending random access to the identified cell within a certain time from the moment that it lost the connection. The UE may further send an RRC Re-establishment Request message to the identified cell within a certain time after receiving a grant. T311 is reset if the UE successfully performs RRC connection re-establishment to a target NB-IoT cell. If T311 expires before the completion of the RRC connection re-establishment, then the UE goes to RRC_IDLE state, and it may initiate cell selection. Parameters T310, T311, N310, and N311 are configured by the PCell, e.g., via RRC messages. T310 can vary between 0 to 8000 ms. T311 can vary from 1000 ms to 30000 ms. N310 can be set from {1, 2, 3, 4, 6, 8, 10, 20}, and N311 can be set from {1, 2, 3, 4, 5, 6, 8, 10}.

### DRX Cycle Operation

The UE can be configured with a DRX cycle to use in all RRC states (e.g., RRC Idle state, RRC Inactive state and RRC Connected state) to save UE battery power. Examples of lengths of DRX cycles currently used in RRC Idle/Inactive states are 256 ms, 320 ms, 640 ms, 1.28 s, 2.56 s, 5.12 s, 10.24 s, etc. Examples of lengths of DRX cycles currently used in RRC Connected state may range from 256 ms to 10.24 s. The DRX cycle is configured by the network node and is characterized by the following parameters:

On duration: During the on duration of the DRX cycle, a timer called ‘onDurationTimer’, which is configured by the network node, is running. This timer specifies the number of consecutive control channel subframes (e.g., NPDCCH slots) at the beginning of a DRX Cycle. It is also interchangeably referred to as DRX ON period. It is the duration (e.g., in number of downlink subframes) during which the UE, after waking up from DRX, may receive control channel (e.g. NPDCCH, wake up signal, etc). If the UE successfully decodes the control channel (e.g., NPDCCH) during the on duration, then the UE starts a DRX-inactivity timer (see below) and stays awake until its expiry.

DRX-inactivity timer: This timer specifies the number of consecutive control channel (e.g., NPDCCH) subframe(s) after the subframe in which a control channel (e.g., NPDCCH) indicates an initial UL or DL user data transmission for this Medium Access Control (MAC) entity. It is also configured by the network node.

DRX active time: This time is the duration during which the UE monitors the control channel (e.g., NPDCCH, wake up signals, etc). In other words, this is the total duration during which the UE is awake. This includes the “on-duration” of the DRX cycle, the time during which the UE is performing continuous reception while the inactivity timer has not expired, and the time the UE is performing continuous reception while waiting for a DL retransmission after one Hybrid Automatic Repeat Request (HARQ) Round Trip Time (RTT). This means the duration over which the DRX-inactivity timer is running is referred to as DRX active time, i.e., no DRX is used by the UE.

DRX inactive time: The time during the DRX cycle other than the active time is called DRX inactive time, i.e., DRX is used by the UE.

The DRX active time and DRX inactive time are also referred to as DRX ON and DRX OFF durations of the DRX cycle respectively, as shown in FIG. 1. The DRX inactive time may also be referred to as non-DRX or non-DRX period. The DRX operation with more detailed parameters is illustrated in FIG. 2. FIG. 3 shows that the DRX active and inactive times may vary depending on UE receiver activity, e.g., DRX inactivity timer is running upon UE being scheduled. This in turn increases DRX active time and proportionally shortens the DRX inactive time.

### Challenges with UE Neighbor Cell Measurements

In RRC Connected state, the NB-IoT UE does not perform any neighbor cell measurements. In order to speed up RRC connection re-establishment upon radio link failure (e.g., expiry of T310 timer), the UE can be configured to perform neighbor cell measurement (e.g., detect a neighbor cell) before the occurrence or triggering of RLF. In addition, the NB-IoT UE may also be configured on a non-anchor carrier, e.g., for receiving/transmitting signals for RLM, etc. Due to these reasons, the UE may not be able to consistently and reliably perform neighbor cell measurements (e.g., detect a neighbor cell) before the occurrence or triggering of RLF. Due to inconsistent UE measurement behavior, the neighbor cell measurement results cannot be reliably used for any mobility-related decisions, e.g., for RRC connection re-establishment, etc.

When the carrier frequencies of the serving cell and measured neighbor cells are different, the UE performs the measurement without gaps, without causing interruptions to the serving cell. In this case, the measurement is performed on occasions where the UE is not scheduled, which includes any of the following:
Vacant slots not scheduled for data transmission, i.e., when not required to do data transmission/reception;
When not required to do NPDCCH monitoring; and
During the DRX Inactive period, i.e., when the UE is configured with DRX.

The UE can be configured with different DRX configurations, e.g., the DRX cycles may vary from 0.256 sec to 10.24 sec. The measurement is further performed on certain types of reference signals which are not always transmitted. For example, cell search requires measurements on NPSS and NSSS, which are transmitted every 10 ms and 20 ms, respectively. Moreover, the UE may still wake up during DRX OFF duration on the serving carrier, to be able to perform time/frequency tracking before reception during the DRX active period. Due to these reasons, it may not always be power efficient, or not even feasible, to switch from one frequency to another to perform measurement on a different carrier. Due to the lack of periodic guaranteed measurement occasions and lack of clear measurement procedures, the UE may not have detected any neighbor cells timely enough to perform cell change upon RLF.

The Background section of this document is provided to place embodiments of the present invention in technological and operational context, to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one embodiment, upon detecting a triggering condition (e.g., a transition between RRC states, a radio link problem (RLP), etc.), a UE determines a relation between a first carrier frequency (F1) of serving cell (cell1) and a second carrier frequency (F2) of a second cell (cell2), and selects one out of multiple measurement procedures to measure on cell2, based on the determined relation between F1 and F2. The UE is configured with F2 by the network node for performing the RRC connection re-establishment procedure, e.g., when RLP is detected. If F1 and F2 are same, then the UE measures on cell2 based on a first measurement procedure, referred to herein as procedure A. However, if F1 and F2 are different, then the UE measures on cell2 based on a second measurement procedure, referred to herein as procedure B. The measurement procedure used for performing measurement on cell2 may further depend on the measurement triggering condition, e.g., based on RRC state change, RLP detection, etc. The UE may further determine the time instance when the UE initiates measurements on cell2 based on the triggering condition.

In procedure A, the UE may measure on any time resource (i.e., measurement occasions are always guaranteed) since it does not have retune its receiver. This type of measurement is interchangeably referred to as intra-frequency measurement, or serving carrier measurement.

In procedure B, the measurements are interchangeably referred to as inter-frequency measurements, or non-serving carrier measurements, and the measurements occasions are limited to specific occasions, where at least a certain number of reference signals are guaranteed. The type of reference signals may depend on type of measurements to be performed, e.g., Radio Resource Management (RRM) measurement may require a certain number of measurement occasions where NRS signals are present, while cell search may require a certain number of measurement occasions where the NPSS/NSSS signals are present. The measurement period (Tm) can be expressed using the general formula:

$$Tm = f ( α , Ns , T max , {Ta}_{j} ) \qquad ( 1 )$$

A specific example of measurement period (Tm), assuming Taⱼ=Ta (e.g., measurement occasions are periodic), is expressed as:

$$Tm = α + Ns * min ( T max , Ta ) , where \qquad ( 2 )$$

α=Implementation margin,
Ta≥Tmin
Tmin=Minimum time interval between two successive measurement occasions which can be used by the UE for measurements, e.g., Tmin=80 ms.
Tmax=Maximum time interval allowed between two successive measurement occasions for performing valid measurement, e.g., Tmax=5 sec.
Taj=Time interval between two successive measurement occasions available for the measurement sample j for performing the measurement over Tm. One measurement occasion comprises at least Ms number of time resources, e.g., symbols, slots, subframes, frames, etc. In one example, Taj=Ts, e.g., assuming that the measurement occasions are periodically available over Tm.
Ns=number of samples or snapshots required for performing certain type of measurement, i.e., Tmeasure is averaged/filtered over Ns samples. Each sample is obtained during a measurement occasion which may comprise one or more time resources. Ns may further depend on type of measurements, e.g., Ns=Ns1 for RRM measurement and Ns=Ns2 for cell search measurement. In one example Ns2>Ns1. Ns may further depend on whether the measured cell is known or unknown.

One embodiment relates to a method, performed by a wireless device, for performing measurements for reestablishing connection with a wireless communication network. A measurement triggering condition is detected. In response to detecting the measurement triggering condition, a second frequency on which to perform measurements is determined. A frequency relation between the first and second frequencies is determined. A measurement procedure for performing one or more measurements on at least one selected cell of the second frequency is selected, based on the determined frequency relation between the first and second frequencies. Measurements are performed on the second frequency according to the selected measurement procedure.

Another embodiment relates to a wireless device operative in a wireless communication network. The wireless device includes communication circuitry and processing circuitry operatively connected to the communication circuitry. the processing circuitry is configured to detect a measurement triggering condition; in response to detecting the measurement triggering condition, determine a second frequency on which to perform measurements; determine a frequency relation between the first and second frequencies; select a measurement procedure for performing one or more measurements on at least one selected cell of the second frequency, based on the determined frequency relation between the first and second frequencies; and perform measurements on the second frequency according to the selected measurement procedure.

Yet another embodiment relates to a method, performed by a first base station operative in a wireless communication network and serving a wireless device, for enabling the wireless device to perform measurements for reestablishing connection with the wireless communication network. The wireless device is served in a first cell belonging to a first frequency. A measurement configuration is transmitted to the wireless device, the measurement configuration identifying a second frequency on which the wireless device may perform measurements. Reference signals are transmitted on the first frequency, whereby the wireless device can detect a Radio Link Problem (RLP) with respect to a first cell. The wireless device, in response to detecting a measurement triggering condition, selects a measurement procedure for performing one or more measurements on at least one selected cell of the second frequency, based on determining that the first and second frequencies are different.

Still another embodiment relates to a first base station operative in a wireless communication network and serving a wireless device. The first base station includes communication circuitry and processing circuitry operatively connected to the communication circuitry. The processing circuitry is configured to serve the wireless device in a first cell belonging to a first frequency; transmit a measurement configuration to the wireless device, the measurement configuration identifying a second frequency on which the wireless device may perform measurements; and transmit reference signals on the first frequency, whereby the wireless device can detect a Radio Link Problem (RLP) with respect to a first cell. The wireless device, in response to detecting a measurement triggering condition, selects a measurement procedure for performing one or more measurements on at least one selected cell of the second frequency, based on determining that the first and second frequencies are different.

Still another embodiment relates to a method, performed by a second base station operative in a wireless communication network, for enabling a wireless device, served in a first cell on a first frequency transmitted by a first base station, to perform measurements for the wireless device to reestablish connection with the wireless communication network. Signals associated with a second cell belonging to a second frequency are transmitted, the signals comprising one of reference signals and system information. The wireless device selects a measurement procedure for performing one or more measurements on the second cell of the second frequency, based on the second frequency being different than the first frequency, in response to detecting a measurement triggering condition.

Still another embodiment relates to second base station operative in a wireless communication network, for enabling a wireless device, served in a first cell on a first frequency transmitted by a first base station, to perform measurements for the wireless device to reestablish connection with the wireless communication network. The second base station includes communication circuitry and processing circuitry operatively connected to the communication circuitry. The processing circuitry is configured to transmit signals associated with a second cell belonging to a second frequency, wherein the signals comprising one of reference signals and system information. The wireless device selects a measurement procedure for performing one or more measurements on the second cell of the second frequency, based on the second frequency being different than the first frequency, in response to detecting a measurement triggering condition.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a timing diagram showing On and Off durations of a UE in DRX.

FIG. 2 is a timing diagram showing a DRX cycle.

FIG. 3 is a timing diagram showing On and Off durations of varying length.

FIG. 4 is a block diagram of an operating scenario whereby a UE is served by Cell1 on F1 and by Cell2 on F1 or F2.

FIG. 5 shows four timing diagrams (A-D) illustrating different timing parameters relating to measurement occasions.

FIG. 6 is a flow diagram of steps in a method, performed by a wireless device, for performing measurements for reestablishing connection with a wireless communication network.

FIG. 7 is a flow diagram of steps in a method, performed by a first base station, for enabling the wireless device to perform measurements for reestablishing connection with the wireless communication network.

FIG. 8 is a flow diagram of steps in a method, performed by a second base station, for enabling the wireless device, to perform measurements for the wireless device to reestablish connection with the wireless communication network.

FIG. 9 is a hardware block diagram of a wireless device.

FIG. 10 is a functional block diagram of a wireless device.

FIG. 11 is a hardware block diagram of a network node configured as a base station.

FIG. 12 is a functional block diagram of a first base station.

FIG. 13 is a functional block diagram of a second base station.

FIG. 14 is a block diagram of a communication system.

FIG. 15 is a block diagram of a User Equipment.

FIG. 16 is a block diagram of a network node.

FIG. 17 is a block diagram of a host.

FIG. 18 is a block diagram of a virtualization environment.

FIG. 19 illustrates host computer communicating via a network node with a user equipment over a partially wireless connection.

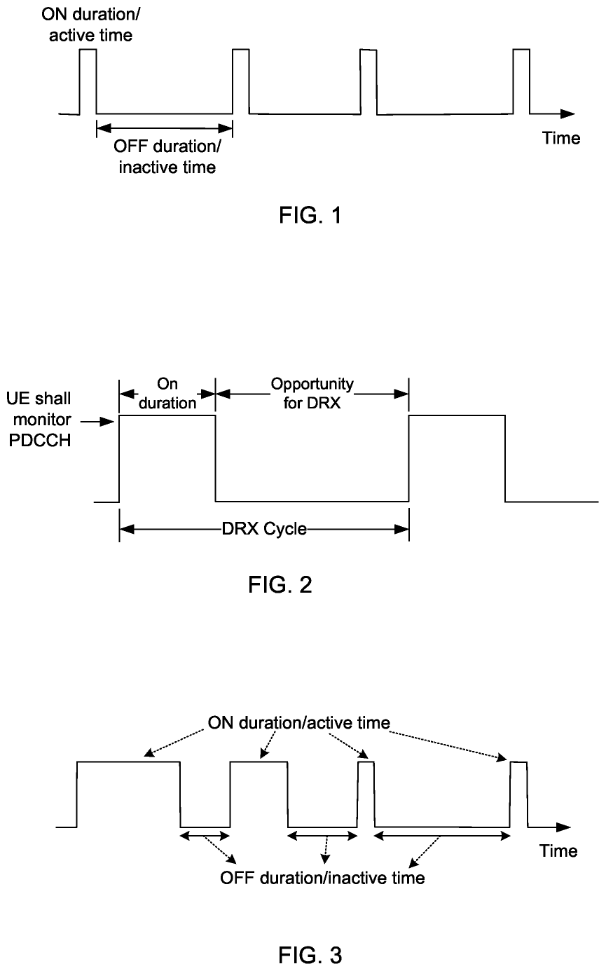

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention. In order to describe aspects of embodiments of the present invention, the specific example of a telecommunications application, executing in a large computing system (also referred to as the cloud) is presented. Those of skill in the art will readily recognize that this example application is not a limitation of embodiments claimed herein, and that the inventive concepts described herein may readily and advantageously be applied to numerous different applications in a computing system.

### Terminology

In some embodiments the general term “network node” is used and it can correspond to any type of radio network node or any network node, which communicates with a UE and/or with another network node. Examples of network nodes are NodeB, MeNB, SeNB, a network node belonging to Master Cell Group (MCG) or Secondary Cell Group (SCG), base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g., MSC, MME, etc.), O&M, OSS, SON, positioning node (e.g. E-SMLC), MDT, test equipment (physical node or software), etc.

In some embodiments, the non-limiting term user equipment (UE) or wireless device is used, and it refers to any type of wireless device communicating with a network node and/or with another UE in a wireless cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, ProSe UE, V2V UE, V2X UE, etc.

The embodiments are described for LTE, e.g., MTC and NB-IoT. However, the embodiments are applicable to any RAT or multi-RAT systems, where the UE receives and/or transmit signals (e.g., data), e.g., LTE FDD/TDD, WCDMA/HSPA, GSM/GERAN, Wi Fi, WLAN, CDMA2000, 5G, NR, etc.

The term time resource as used herein may correspond to any type of physical resource or radio resource expressed in terms of length of time. Examples of time resources include: symbol, mini-slot, time slot, subframe, radio frame, Transmission Time Interval (TTI), short TTI, interleaving time, etc.

The term signal or radio signal as used herein can be any physical signal or physical channel. Examples of DL physical signals are reference signals (RS) such as NPSS, NSSS, NRS, CSI-RS, DMRS, signals in SSB, DRS, CRS, PRS etc. Examples of UL physical signals are reference signal such as SRS, DMRS etc. The term physical channel refers to any channel carrying higher layer information, e.g., data, control etc. Examples of physical channels are PBCH, NPBCH, PDCCH, PDSCH, MPDCCH, NPDCCH, NPDSCH, E-PDCCH, PUSCH, PUCCH, NPUSCH, etc.

The term carrier frequency used herein refer to a frequency of a cell which can be a serving cell or a non-serving cell. In Time Division Duplex (TDD), the same carrier frequency is used in UL and DL for the same cell. In Frequency Division Duplex (FDD) or HD-FDD, different carrier frequencies are used in UL and DL for the same cell. One or a plurality of cells can operate on the same carrier frequency. The carrier frequency may also be referred to as simply carrier, frequency, frequency channel, radio channel, etc. The carrier frequency can be indicated or signaled by the network to the UE or by the UE to network (e.g., with measurement results) by a carrier frequency number or identifier or radio channel number or identifier referred to as Absolute Radio Frequency Channel Number (ARFCN), E-UTRAN ARFCN (EARFCN), etc. There are separate ARFCN or EARFCN for UL and DL in FDD or HD-FDD.

The UE performs measurements on one or more reference signals (RS) transmitted in a cell, which can be a serving cell or neighbor cell. The measured cell can operate on or belong to the serving carrier frequency (e.g., an intra-frequency carrier) or it can operate on or belong to a non-serving carrier frequency (e.g., an inter-frequency carrier, inter-RAT carrier, etc.). Examples of RS are given above. Examples of measurements are cell identification (e.g., PCI acquisition, cell detection), Reference Symbol Received Power (RSRP), Reference Symbol Received Quality (RSRQ), secondary synchronization RSRP (SS-RSRP), narrowband RSRP (NRSRP), narrowband RSRQ (NRSRQ), SS-RSRQ, SINR, RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, Radio Link Monitoring (RLM), which consists of Out of Synchronization (out of sync) detection and In Synchronization (in-sync) detection, etc. CSI measurements performed by the UE are used for scheduling, link adaptation, etc. by the network. Examples of CSI measurements or CSI reports are CQI, PMI, RI, etc. They may be performed on reference signals like CRS, CSI-RS or DMRS.

The term measurement occasion (MO) as used herein comprises any time instance or time duration over which the UE can perform one or more measurements on signals of one or more cells. MO can be expressed in terms of a duration, e.g., X1 seconds or ms, or X2 number of time resources. The MO can occur periodically or aperiodically. The MO may also be referred to as measurement opportunity, measurement resources, measurement instances etc.

The term serving cell inactive time resources as used herein may also be simply called as inactive time resources or inactive resources. During the inactive time resources the UE is not expected to operate signals in the serving cell. A UE operating a signal in a serving cell comprises receiving signals and/or transmitting signals in the serving cell. More specifically, during the inactive time, inactive time resources are resources the UE is not expected to be scheduled for receiving and/or transmitting signals in the serving cell. On the other hand, during active time resources, the UE can be scheduled in the serving cell. Examples of inactive time resources are DRX inactive time, invalid time resources (ITR), UL gaps for DL synchronization, etc. The inactive time resource may also be referred to as inactive time period, inactive time duration, inactive time occasion, etc.

One scenario comprises a UE served by a first cell (cell1). Cell1 is managed or served or operated by a network node (NW1), e.g., a base station.

### Operating Scenario

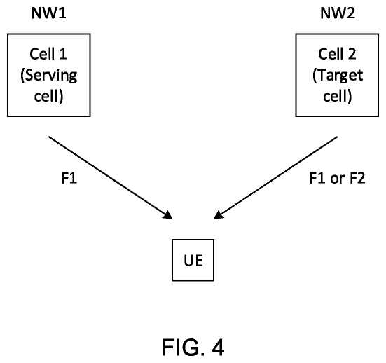

FIG. 4 depicts a scenario in which a UE is served by a serving cell (cell1) operating in a first carrier frequency (F1). Cell1 is managed or operated by a first network node (NW1, e.g., BS, eNB). Carrier, F1, can be an anchor carrier or it can be a non-anchor carrier. The UE operates in a certain coverage enhancement (CE) level with respect to cell1. The UE is configured to receive signals (e.g., paging, WUS, NPDCCH, NPDSCH, PDSCH, etc.) from at least cell1.

The UE is further configured to perform RLM on signals of cell1, e.g., on NRS. Therefore, the UE regularly evaluates radio link quality on reference signals (e.g., NRS) of cell1 to detect in-sync (IS) or out of sync (OOS) conditions. The UE performs RLM on cell1 regardless of whether F1 is an anchor carrier or a non-anchor carrier. Upon the occurrence of radio link failure with respect to cell1, the UE may initiate an RRC connection re-establishment procedure to a target cell (cell2). Cell2 may belong to F1 (i.e., the carrier of serving cell) or it may belong to a different carrier frequency, a second carrier frequency (F2), which is different than F1. Therefore, carrier frequency of cell2 (F1 or F2 or any other carrier) may be an anchor carrier or non-anchor carrier. The one or more carrier frequencies on which the UE is required to perform RRC connection re-establishment may be configured by the network node. The UE may or may not be configured in DRX.

### Methods in a UE for Measuring on Neighbor Cells During RLM

The UE may start or initiate performing one or more measurements on one or more cells (e.g., cell2) on one or more carriers (e.g., FR2) configured for RRC connection re-establishment procedures when one or more measurement triggering conditions are met. Examples of triggering conditions are when a RLP is detected, and when UE RRC state changes and cell2 is known to the UE at the RRC state transition, e.g., cell2 is known to the UE when UE changes from RRC Idle to RRC Connected state, etc.

The method of measurement for RRC connection reestablishment in the UE includes the following actions.

A measurement triggering condition is detected. For example, the UE may detect a radio link problem (RLP) with respect to cell1 belonging to F1. As another example, the UE may detect that it has changed its RRC state, and cell2 is known to the UE at the RRC state transition. As an example, cell2 is known to the UE when RRC state changes from low activity RRC state to higher activity RRC state, such as from RRC Idle state to RRC Connected state, or from RRC Inactive state to RRC Connected state, etc.

Upon detecting at least one measurement triggering condition, a frequency F2 for performing measurement is determined.

A frequency relation between F1 and F2 is determined.

A measurement procedure is selected for one or more measurements on at least one cell (e.g., cell2) of F2, based on the determined frequency relation between F1 and F2. Measurement procedure A is selected if F1 and F2 are the same. Procedure A may further depend on the measurement triggering condition. Measurement procedure B is selected if F1 and F2 are different. Procedure B may further depend on the measurement triggering condition.

Measurements are performed on F2 based on the selected measurement procedure.

The measurement is then used for one or more tasks.

These above steps can be performed in the UE in different order(s) than listed above. The method steps are described in detail below:

### Determining Measurement Triggering Conditions

In a first example, the measurement triggering condition is determined based on the change in the UE RRC state and the status of cell2—i.e., whether it is known or unknown to the UE at the time of the RRC state transition. Cell2 operates on F2 which is configured by the network node for RRC connection re-establishment procedure, e.g., via higher layer signaling such as RRC. In this example, the UE may initiate the measurements on cell2 if the following two conditions are met:

First, the UE RRC state has changed or transitioned, e.g., from Idle/Inactive state to Connected state. The UE can determine the state change based on one or more of, e.g., explicit message received from the network node changing the UE RRC state, expiry of timer, triggering of condition (e.g., paging message), triggering of data transmission and/or reception, etc.

Second, cell2 is known to the UE at the time of the RRC state change. In one example, cell2 may be known to the UE if the UE was measuring cell2 before the RRC state change, e.g., until or at least until certain time (e.g., 5 seconds) before the RRC state change. In another example, cell2 may be known to the UE if cell2 was the UE's serving cell before the RRC state change, e.g., the serving cell in RRC Idle/Inactive state. As stated above, F2 is one of the carriers configured for RRC connection re-establishment. Therefore, the triggering condition is met if F2 is also configured for measurements before the RRC state change, e.g., for RRC Idle/Inactive measurements. A carrier frequency (e.g., F2), when configured for both RRC Idle/Inactive measurement and RRC connection re-establishment procedures, may be referred to as an overlapping carrier, or common carrier, or intersecting carrier.

A cell is considered to be known if the UE has performed a measurement (e.g., obtained at least one measurement sample) within the last Tp time period; otherwise, the cell is considered to be unknown to the UE. The UE is aware of the cell ID (e.g., PCI), and may maintain cell timing of the known cell. In one example, Tp=5 seconds. In another example, Tp corresponds to the measurement time for a measurement, e.g., cell identification time period, evaluation time, etc. In another example, Tp corresponds to X1 number of DRX cycles, e.g., X1=5. In another example, Tp corresponds to a function of two or more of: X1 number of DRX cycles, cell identification time period, fixed time period (Tf), etc. Examples of functions are average, maximum, sum, product, etc.

In a second example, the measurement triggering condition is determined based on whether the UE has detected a Radio Link Problem (RLP) with respect to cell1. In this example, the UE may initiate the measurements on cell2 if the UE has detected RLP with respect to cell1; otherwise, the UE does not initiate the measurements on cell2. The RLP with respect to cell1 corresponds to the state in which the UE may not be able to maintain an acceptable radio link quality of cell1. For example, the UE does not, or it may not be able to, successively receive or decode a control channel (e.g. NPDCCH) from cell1 because of a low SNR or SINR condition. The UE can detect RLP in cell1 based on one or more criteria, which can be pre-defined or configured by the network node. As an example, the UE may detect RLP in cell1 based on one or more of the following criteria:
Upon detecting N1 consecutive number of OOS detection, e.g., N1=4.
Upon detecting N1 number of OOS detection over certain time period (T1), where N1 can be consecutive or non-consecutive OOS detection, e.g., T1=1 second.
Upon starting an RLF timer (e.g., T310), e.g., T310 may start upon detecting N consecutive OOS indication from the layer 1 processing.
Upon a running RLF timer exceeding a threshold, e.g., T2 seconds.
Upon triggering an early Qout event (e.g., event E1). The early Qout event (event E1) may be triggered when the signal quality is slightly higher than that corresponding to out-of-sync triggering threshold. This means the early Qout event (e.g., event E1) is triggered before the actual OOS detection. This enables the UE to take an appropriate action, e.g., adapt its receiver, etc.
Upon serving cell quality (e.g., NRSRQ, SINR, etc.) falling below a threshold.
Upon serving cell quality (e.g., NRSRQ, SINR, etc.) falling and staying below a threshold over a certain time period, e.g., T3 seconds.
Upon serving cell quality (e.g., NRSRQ, SINR, etc.) falling and staying below a threshold for a certain ratio or percentage of time over a time period, e.g., T4 seconds over T5 seconds or X % of T5 seconds
Upon a large enough drop in serving cell quality (e.g., NRSRQ, SINR, etc.) compared to the strongest serving cell quality (e.g., NRSRQ, SINR, etc.) after the UE connects to cell1.
Upon a large enough drop in serving cell quality (e.g., NRSRQ, SINR, etc.) compared to strongest serving cell quality (e.g., NRSRQ, SINR, etc.) after the UE connects to cell1 and stays there greater than a certain time period, e.g., T6 seconds
When the UE is not able to successfully receive the control channel (e.g., NPDCCH) from the serving cell.

### Determining Carrier(s) for Performing Neighbor Cell Measurement(s)

The detection or determination of the one or more measurement conditions triggers the UE to determine information about at least one carrier frequency (F2) for performing one or more measurements (e.g., NRSRP, NRSRQ, etc.) on one or more cells of that carrier. The carrier frequency information may comprise or be denoted by one or more of: the carrier frequency channel number (e.g., absolute frequency channel number such as ARFCN, E-UTRA ARFCN (EARFCN), etc.), or the raster of the carrier frequency, e.g., the center frequency of the carrier may be placed at the raster point in frequency.

The UE may further determine additional information related to the carrier on which the measurement is to be performed. For example, the UE may determine an indication whether the carrier is anchor or non-anchor carrier. As another example, the UE may determine the priority of the carrier with which the UE will do measurement.

The UE can determine the carrier, F2, based on a measurement configuration received from the network node, e.g., cell1. In one example, the information can be received via an RRC message in advance, and stored in the UE. The UE can then retrieve the carrier frequency information from its memory. In another example, upon detecting the triggering conditions (e.g., RRC state change, RLP, etc.), the UE requests the network node to provide the UE with the measurement configuration for doing measurements, e.g., for RRC re-establishment. The UE may receive the requested measurement configuration containing information about at least one carrier frequency. In yet another example, the UE may use historical data or past statistics related to measurements performed by the UE, and use those results for determining at least one carrier frequency for measurements. In still another example, the UE may determine F2 autonomously based on, e.g., a blind search that involves UE scanning neighboring frequencies or frequency locations and looking for synchronization signals.

### Determining a Relation Between F1 and F2

In this step, the UE determines a relation between frequencies of the serving carrier frequency (F1) (i.e., carrier of cell1) and at least one carrier frequency (F2) of at least one cell (cell2) on which the UE is expected to perform measurement, upon triggering of the at least one measurement triggering conditions. The UE may further determine a frequency relation between F1 and any number (n) of carrier frequencies (e.g., F2, F3, . . . , Fn), e.g., a relation between F1 and F2, between F1 and F3, and so on. For simplicity, the idea of frequency relation is explained for two carriers, e.g., between F1 and F2. However, it applies to any pair of carriers.

One example of a frequency relation between F1 and F2 is whether F1 and F2 are the same, e.g., have the same frequency channel number, e.g., the same EARFCN. F1 and F2 are the same if they have the same frequency channel number.

Another example of a frequency relation between F1 and F2 is whether F1 and F2 are different, e.g., have different frequency channel numbers, e.g., different EARFCNs. F1 and F2 are different if they have different frequency channel numbers.

Yet another example of a frequency relation between F1 and F2 is whether F1 and F2 have the same center frequency, or substantially the same center frequencies (e.g., within ±ΔF). Where ΔF is a margin, such as frequency error, e.g., ±0.1 ppm, ±200 kHz, etc., F1 and F2 are the same if their center frequencies are the same or are substantially the same; otherwise, F1 and F2 are different.

Still another example of a frequency relation between F1 and F2 is whether F1 and F2 are configured at the same raster points in the frequency domain. F1 and F2 are the same if they are configured at the same raster point; otherwise, F1 and F2 are different.

F2 may be assumed to be an anchor carrier since a cell change (e.g., RRC re-establishment) is performed on the anchor carrier. After the cell change to the target cell (e.g., cell2), the UE has to acquire its system information, etc.

The UE may determine the frequency relation, for example, by comparing one or more of: the EARFCNs of the carriers, center frequencies, raster, etc. The UE may further determine whether F1 is anchor or non-anchor carrier, for example based on received information, e.g., in a measurement configuration, which contains an indication whether the carrier is an anchor or non-anchor carrier. The UE may further determine whether F1 is an anchor or non-anchor carrier, for example based on historical information, e.g., whether UE has detected anchor carrier specific signals (e.g., NPSS/NSSS, NPBCH, etc.) or system information (e.g., MIB-NB, SIB1-NB, etc.) on the carrier or not, in the past.

### Selecting a Measurement Procedure for Performing Measurements on F2

The UE selects one of plurality of measurement procedures based on the determined frequency relationship between F1 and F2. If F1 and F2 are same, then UE selects and applies measurement procedure A for measuring on F2. Otherwise, if F1 and F2 are different, then the UE selects and applies measurement procedure B for measuring on F2. Each measurement procedure can be based on a rule, which can be pre-defined or configured by the network node.

The measurement procedure A applied by the UE (when F1 and F2 are the same) may further comprise procedure A1 or A2, which may depend on the measurement triggering conditions as described below with examples.

In one example, if F1 and F2 are the same, and the measurement triggering condition is based on the RRC state transition, then the UE selects measurement procedure A=A1 for measuring on F2.

In another example, if F1 and F2 are the same, and the measurement triggering condition is based on the RLP detection, then the UE selects measurement procedure A=A2 for measuring on F2.

In another example, if F1 and F2 are the same, and multiple measurement triggering conditions are met (e.g., based on RRC state change and based on the RLP detection), then the UE selects one of the measurement procedures A1 and A2 for measuring on F2. The selection between A1 and A2 can be based on a rule, which can be pre-defined or configured by the network node. In one example of the rule, the UE applies procedure A2. In another example of the rule, the UE applies procedure A1. In another example of the rule, the UE applies the procedure which enables the UE to perform the measurement on cell2 over the shortest time period.

In another example, if F1 and F2 are the same, and regardless of the measurement triggering conditions, the UE selects the same measurement procedure A (e.g., A1 or A2) for measuring on F2.

In another example, if F1 and F2 are the same, and initially the measurement triggering condition is only based on the RRC state transition, then the UE first selects and applies measurement procedure A=A1 for measuring on F2. If, at later time, the measurement triggering condition is further based on the RLP detection, then UE changes the measurement procedure from A1 to A2 for measuring on F2, and applies the measurement procedure A=A2 for measuring on F2. For example, at time instance Tr, the UE only detects that the measurement is triggered based on the RRC state transition. At time instance Tf, the UE further detects that the measurement is triggered based on the RLP detection; where Tf occurs after Tr, e.g., Tf>Tr. In this example, the UE measures cell2 from Tr until Tf using measurement procedure A1 and measures cell2 from Tf on using measurement procedure A2.

The measurement procedure B applied by the UE (when F1 and F2 are different) may further comprise procedure B1 or B2, which may depend on the measurement triggering conditions as described below with examples.

In one example, if F1 and F2 are different, and the measurement triggering condition is based on the RRC state transition, then the UE selects measurement procedure B=B1 for measuring on F2.

In another example, if F1 and F2 are different, and the measurement triggering condition is based on the RLP detection, then the UE selects measurement procedure B=B2 for measuring on F2.

In another example, if F1 and F2 are different, and multiple measurement triggering conditions are met (e.g., based on RRC state change and based on the RLP detection), then the UE selects one of the measurement procedures B1 and B2 for measuring on F2. The selection between B1 and B2 can be based on a rule, which can be pre-defined or configured by the network node. In one example of the rule, the UE applies procedure B2. In another example of the rule, the UE applies procedure B1. In another example of the rule, the UE applies the procedure which enables the UE to perform the measurement on cell2 over the shortest time period.

In another example, if F1 and F2 are different, and regardless of the measurement triggering conditions, the UE selects the same measurement procedure B (e.g., B1 or B2) for measuring on F2.

In another example, if F1 and F2 are different, and initially the measurement triggering condition is only based on the RRC state transition, then the UE first selects and applies measurement procedure B=B1 for measuring on F2. If, at later time, the measurement triggering condition is further based on the RLP detection, then the UE changes measurement procedure from B1 to B2 for measuring on F2, and applies the measurement procedure B=B2 for measuring on F2. For example, at time instance Tr, the UE only detects that the measurement is triggered based on an RRC state transition. At time instance Tf, the UE further detects that the measurement is triggered based on the RLP detection; where Tf occurs after Tr, e.g., Tf>Tr. In this example, the UE measures cell2 from Tr until Tf using measurement procedure B1, and measures cell2 from Tf on using measurement procedure B2.

In procedure A (A1 or A2), the UE may measure on any time resource (i.e., measurement occasions are always guaranteed) since the UE does not have to retune its receiver because the center-frequency is assumed to be same. The measurement performed based on procedure A is interchangeably referred to as intra-frequency measurement, or serving carrier measurement. In this case, the UE may measure on any time duration, regardless of UE activity states (e.g., DRX ON or DRX OFF) and the measurement can be performed in parallel with the serving cell measurement (cell1) on F1. The procedures A1 and A2 may differ in terms of one or more of their, e.g., measurement sampling rates, number of measurement samples, measurement periods over which the UE performs the measurement, validity time or condition, etc.

In one example, the measurement period (Ta1) for performing a measurement in procedure A1 is longer than the measurement period (Ta2) for performing the same measurement in procedure A2.

In another example, a measurement sample for performing a measurement in procedure A1 is obtained once every Ta3, whereas a measurement sample for performing the same measurement in procedure A2 is obtained once every Ta4; where Ta3 and Ta4 are different. In one example, Ta3>Ta4. In one specific example, Ta3=5 seconds and Ta4=80 ms.

In another example, the measurement period in procedure A can be expressed using a fixed period (e.g., 800 ms, 1600 ms, 3200 ms, 5 seconds, etc.) or in terms of number of DRX cycles (e.g., 20 DRX cycles, 40 DRX cycles, etc.). However, the value of the measurement period can be different for procedure A1 and A2, e.g., 5 seconds for procedure A1 and 1600 ms for procedure A2.

In another example, the UE performs a measurement using procedure A1 while the cell remains known. When the cell (e.g., cell2) becomes unknown, then the UE does not perform the measurement anymore and does not detect the cell again. In procedure A2, the UE may again try to detect the cell after the cell becomes unknown. A cell may become unknown due to, for example, the received signal level of the cell at the UE staying below certain threshold over certain time, e.g., SINR remains below −6 dB over more than 5 seconds. This may prevent the UE from obtaining valid measurement samples.

In procedure B, the UE measures on a specific (limited) set of measurement occasions when the specific types of reference signals (e.g., NRS, NPSS, NSSS, etc.) are guaranteed to be available at the UE. The measurements are performed over Ns number of samples which are averaged over a measurement time period (Tm) (e.g., Tmeasure, Tidentify).

The measurement periods, Tb1 and Tb2 for procedure B1 and for procedure B2, respectively, may also be different, e.g., Tb1>Tb2. The measurement sampling rates Rb1 and Rb2 for procedure B1 and for procedure B2, respectively, may also be different, e.g., Rb1<Rb2. The measurement sampling rate is the number of samples per unit time, or interval between successive samples.

In another example, the UE performs a measurement using procedure B1 while the cell remains known. When the cell (e.g., cell2) becomes unknown, then the UE does not perform the measurement anymore, and does not detect the cell again. In procedure B2, the UE may again try to detect the cell after the cell becomes unknown. A cell may become unknown due to, for example, the received signal level of the cell at the UE staying below a threshold over a certain time, e.g., the SINR remains below-6 dB over more than 5 seconds. This may prevent the UE from obtaining valid measurement samples.

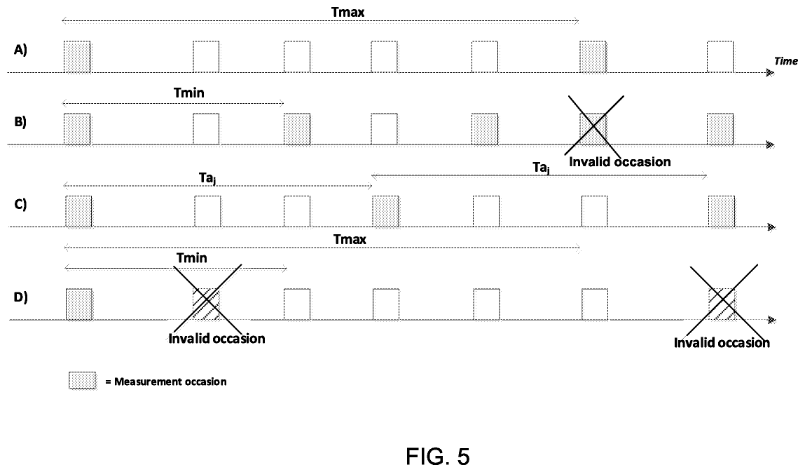

In a general example, the measurement period (Tm) for performing the measurement according to measurement procedure B (B1 or B2) can be expressed using the following formula, as illustrated in FIG. 5:

$$Tm = f ( α , Ns , T max , {Ta}_{j} ) \qquad ( 3 )$$

In FIG. 5, case A) illustrates the maximum time interval allowed between two successive measurement occasions using Tmax. Similarly, case B) shows the minimum time interval Tmin. Note that the measurement occasion depicted second from the right is invalid, as it violates the interval Tmin since the immediately prior measurement occasion. Case C) shows the actual time interval between two successive measurement occasions available for measurement at sample j. Case D) shows further examples of invalid measurement occasions, as both the Tmin condition and Tmax conditions are not met. Examples of functions, f( ), in equation (3) are maximum, minimum, sum, average, and any combination of two or more functions.

One specific example of the measurement period (Tm) can be expressed as:

$$Tm = α + {\sum }_{k = 1}^{Ns} MIN ( T max , {Ta}_{j} ) \qquad ( 4 )$$

Another specific example of the measurement period (Tm) where Taⱼ=Ta for all Ns number of samples can be expressed as:

$$Tm = α + Ns * min ( T max , Ta ) , where \qquad ( 5 )$$

Taⱼ≥Tmin and
α=implementation margin. In one example, α=0. In another example, α>0. In another example, α=Tmin.
Tmin=Minimum time interval between two successive measurement occasions which can be used by the UE for measurements. Tmin may further depend on whether the UE is applying procedure B1 or B2. Therefore, Tmin=Tmin1 or Tmin=Tmin2. For example, Tmin1 and Tmin2 may correspond to the measurement performed by the UE based on procedure B1 and B2, respectively. Tmin1 and Tmin2 are different. In one example Tmin1>Tmin2. In one specific example, Tmin1=1600 ms and Tmin=80 ms. In another specific example, Tmin=5 seconds and Tmin=80 ms. In another specific example, Tmin1 corresponds to the duration over which the cell remains known.
Tmax=Maximum time interval allowed between two successive measurement occasions for performing valid measurement. In one example, Tmax may be a fixed value, e.g., Tmax=5 sec. In another example Tmax may correspond to a time period within which, if the UE cannot obtain at least two successive samples, then the cell may become unknown. Tmax may further depend on whether the UE is applying procedure B1 or B2. Therefore, Tmax=Tmax1 or Tmax=Tmax2. For example, Tmax1 and Tmax2 may correspond to the measurement performed by the UE based on procedure B1 and B2 respectively. In one example, Tmax1>Tmax2, e.g., Tmax1=5 seconds and Tmax2=4 seconds.
Taⱼ=Time interval between two successive measurement occasions available for measurement sample j obtained for the measurements. One measurement occasion comprises at least Ms number of time resources, e.g., symbols, slots subframes, frames, etc. As shown in FIG. 5, Taj is not fixed, and its actual value can vary between Tmin and Tmax. In one example, Taj is different for obtaining different measurements samples, e.g., due to availability of the measurement occasions, which may not occur periodically over the measurement period, Tm. In another example, Taj is the same for obtaining different measurements samples, e.g., due to availability of the measurement occasions which may occur periodically over the measurement period, Tm. In this case, Taj=Ta over the measurement period.
Ns=number of samples or snapshots required for performing a certain type of measurement. Each sample is obtained during a measurement occasion, which may comprise one or more time resources. This means the measurement is performed over Ns number of measurement occasions during the measurement period. Different functions can be applied over the Ns number of measurement samples during the measurement period to obtain the measurement results. Examples of functions include averaged value, maximum value, maximum absolute values, product, etc.

Ns may further depend on the type of measurements. For example, Ns=Ns1 for one type of RRM measurement (e.g., NRS based NRSRP measurement); Ns=Ns2 for another type of RRM measurement (e.g., NSSS based NRSRP measurement); and Ns=Ns3 for cell search measurement (e.g., NPSS/NSSS based measurement). The parameters Ns for different types of measurements may or may not be related to each other. In one example, Ns1<Ns2<Ns3 because NRS are transmitted more frequently (e.g., in every available DL subframe) than the synchronization signals, which are transmitted every 10 ms (NPSS) and 20 ms (NSSS). The synchronization signals are transmitted at least on subframes #0, #4, #5 and #9.

Ns may further depend on whether the measured cell is known or unknown to the UE. If the measured cell is already known (e.g., measured in the last 5 seconds), then Ns refers to the number of measurement samples needed to perform the RRM measurement (e.g., NRSRP, NRSRQ, etc.). Example values of Ns can be 10 for normal coverage and 20 for enhanced coverage. However, if the measured cell is unknown, then Ns refers to the number of measurement samples needed to first detect the cell, and thereafter perform a measurement on that cell. In this case, Ns can be a function of two components:

Ns=f(Ns−d,Ns−m) where
Ns−d is the number of downlink measurement samples obtained in resources containing subframes #0, #4, #5 and #9 that are available within min (Tmin, Ta). In the case the cell is already known, then Ns−d can be assumed to be 0.
Ns−m is the number of downlink measurement samples obtained in resources containing NRS subframes within min (Tmin, Ta).

In one example, the function can be an addition, i.e. Ns=Ns−d+Ns−m.

In a first example, where the measurement is an NRS based NRSRP measurement performed in normal coverage (NSCH Ês/lot≥−6 dB and NRS Ês/lot≥−6 dB), the neighbor cell requirements upon detecting one or more measurement triggering conditions (e.g., RLF detection) apply provided at least one downlink subframe containing the NRS signals of the measured cell is available within min (Tmax, Ta) at the UE for NRSRP measurement, assuming the measured cell is identified cell over Tm.

In one specific example, the total measurement period for procedure B1 can be expressed as:

Ns*min(Tmax,Ta)=32 seconds, where
Ns=10, assuming the measurement is averaged over 10 samples;
Tmax=Tmax1=5 seconds, assuming the maximum length between two measurement occasion is 5 seconds; and
Ta≥Tmin1=3200 ms, assuming the minimum length between two measurement occasion is 3200 ms.

In another specific example, the measurement period for procedure B1 can be expressed as:

Ns*min(Tmax,Ta)=800 ms, where
Ns=10, assuming the measurement is averaged over 10 samples;
Tmax=Tmax2=5 seconds, assuming the maximum length between two measurement occasion is 5 seconds; and
Ta≥Tmin2=80 ms, assuming the minimum length between two measurement occasion is 80 ms.

In a second example, where the measurement is a NRS based NRSRP measurement performed in enhanced coverage (−15 dB≤NSCH Ês/lot<−6 dB and −15 dB≤NRS Ês/lot<−6 dB), the neighbor cell requirements upon RLF detection apply provided at least two consecutive downlink subframes containing the NRS signals of the measured cell are available within min (Tmax, Ta) at the UE for NRSRP measurement, assuming the measured cell is identified cell over Tm.

In one example, the total measurement period for procedure B1, assuming Ta is the same for all measurement samples, can be expressed as

Ns*min(Tmax,Ta)=64 seconds, where
Ns=20, assuming the measurement is averaged over 20 samples;
Tmax=5 seconds, assuming the maximum length between two measurement occasion is 5 seconds; and
Ta≥Tmin1=3200 ms, assuming the minimum length between two measurement occasion is 80 ms.

In another example, the total measurement period for procedure B2, assuming Ta is the same for all measurement samples, can be expressed as

Ns*min(Tmax,Ta)=1600 ms, where
Ns=20, assuming the measurement is averaged over 20 samples;
Tmax=5 seconds, assuming the maximum length between two measurement occasion is 5 seconds; and
Ta≥Tmin2=80 ms, assuming the minimum length between two measurement occasion is 80 ms.

In this example, two consecutive subframes are assumed for each sample, since the UE is operating under low SINR conditions, and thus needs to accumulate the energy over more reference signals.

In a third example, where the measurement is a cell detection based on NPSS/NSSS in normal coverage (NSCH Ês/lot≥−6 dB and NRS Ês/lot≥−6 dB), the neighbor cell requirements upon RLF detection apply provided at least downlink subframes #0, #4, #5, or #9 containing (NPSS, NSSS) of the measured cell are available within min (Tmax, Ta) at the UE, for an inter-frequency cell to be identified by the UE, is available at the UE over Tidentify.

In one example, the total measurement period for cell detection using procedure B1, assuming Ta is the same for all measurement samples, can be expressed as:

Ns*min(Tmax,Ta)=128 seconds, where
Ns=40, assuming 40 attempts are needed to correctly identify the target cell;
Tmax=5 seconds, assuming the maximum length between two measurement occasion is 5 seconds; and
Ta≥Tmin2=3200 ms, assuming the minimum length between two measurement occasion is 80 ms.

In another example, the total measurement period for cell detection using procedure B2, assuming Ta is the same for all measurement samples, can be expressed as:

Ns*min(Tmax,Ta)=3200 ms, where
Ns=40, assuming 40 attempts are needed to correctly identify the target cell;
Tmax=5 seconds, assuming the maximum length between two measurement occasion is 5 seconds; and
Ta≥Tmin2=80 ms, assuming the minimum length between two measurement occasion is 80 ms.

### Performing Measurement on F2 Based on the Selected Measurement Procedure and Using the Measurement for One or More Tasks

After selecting the measurement procedure, as described above, the UE performs one or more measurements on one or more cells of F2, upon detecting the RLP on cell1. It is assumed that the UE is configured with at least one carrier, F2, for doing the measurements. However, the UE may be configured with more than one carrier (e.g., F2, F3), or more generally with n−1 number of carriers (e.g., F2, F3, . . . , Fn) for performing the measurements upon detecting RLP.

The measurement herein may typically comprise detecting a target cell (e.g., cell2) on F2 using synchronization signals (e.g., NPSS/NSSS) transmitted by the target cell. This requires the UE to typically perform correlation over NPSS/NSSS with pre-defined sets of NPSS/NSSS periodically (e.g., once every 20 or 40 ms), depending on the signal quality (e.g., SINR) of the target cell. For example, the UE may detect the cell within 2-4 attempts (e.g., each attempt every 20-40 ms) if the SINR is above a threshold, e.g., −3 dB or higher. Otherwise, the UE may detect the cell within a larger number of attempts (e.g., 4-20) if the SINR is below the threshold, e.g., below-3 dB. The UE may further perform the signal power measurements (e.g., NRSRP) using NRS on the target cell (cell2) after it has been detected. The signal measurement is used for deciding to select between cells for cell change in case the UE has detected more than one cell. For example, the UE may select a cell whose NRSRP is the largest among all the cells. The UE may further select a cell whose NRSRP is the largest among all the cells, but whose NRSRP is also above a certain threshold.

After selecting the detected cell, the UE will use it for performing one or more tasks. For example, the UE may perform RRC connection re-establishment on the selected cell. The UE may also acquire the system information of the selected cell. The UE may also inform the base station (e.g., on the new cell) that it has successfully performed the RRC connection re-establishment, e.g., by sending a higher layer message.

If one cell is detected during T310 running time, to reduce the time taken for RRC reestablishment to this detected cell, the RLF timer T310 can be terminated earlier, RLF can be declared directly, and RRC reestablishment can be started earlier. Alternatively, if one cell is detected during T310 running time, and some pre-defined conditions are satisfied, then the RLF timer T310 can be terminated earlier, RLF can be declared directly, and RRC reestablishment can be started earlier. For example, the pre-defined conditions can be defined by a new short timer T1, which is started after one cell is detected and when T1 expires, then T310 can be stopped.

### Methods and Apparatuses

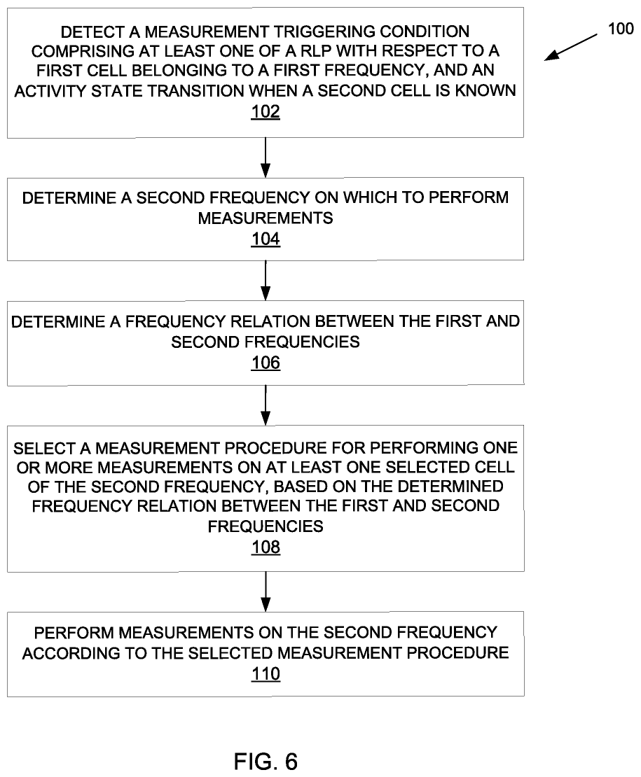

FIG. 6 depicts a method 100, performed by a wireless device, for performing measurements for reestablishing connection with a wireless communication network, in accordance with particular embodiments. A measurement triggering condition, comprising at least one of a Radio Link Problem (RLP) with respect to a first cell belonging to a first frequency, and an activity state transition when a second cell is known, is detected (block 102). In response to detecting the measurement triggering condition, a second frequency on which to perform measurements is determined (block 104). A frequency relation between the first and second frequencies is determined (block 106). A measurement procedure for performing one or more measurements on at least one selected cell of the second frequency is selected, based on the determined frequency relation between the first and second frequencies (block 108). Measurements are performed on the second frequency according to the selected measurement procedure (block 110).

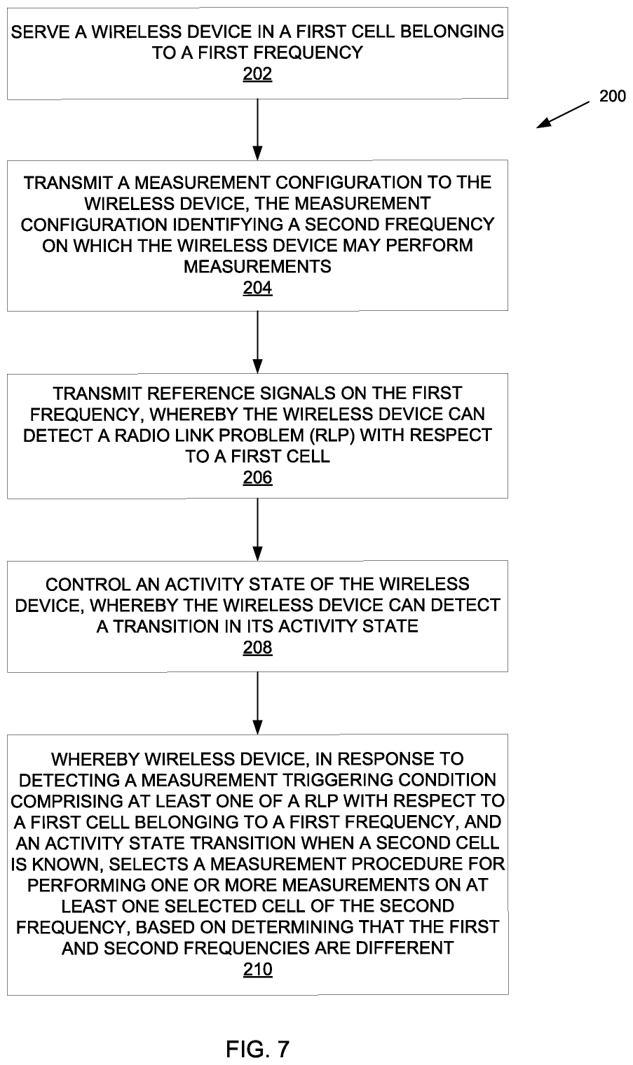

FIG. 7 depicts a method 200, performed by a first base station operative in a wireless communication network and serving a wireless device, for enabling the wireless device to perform measurements for reestablishing connection with the wireless communication network, in accordance with other particular embodiments. The wireless device is served in a first cell belonging to a first frequency (block 202). A measurement configuration is transmitted to the wireless device, the measurement configuration identifying a second frequency on which the wireless device may perform measurements (block 204). Reference signals are transmitted on the first frequency, whereby the wireless device can detect a Radio Link Problem (RLP) with respect to a first cell (block 206). An activity state of the wireless device is controlled, whereby the wireless device can detect a transition in its activity state (block 208). The wireless device, in response to detecting a measurement triggering condition comprising at least one of a RLP with respect to a first cell belonging to a first frequency, and an activity state transition when a second cell is known, selects a measurement procedure for performing one or more measurements on at least one selected cell of the second frequency, based on determining that the first and second frequencies are different (block 210).

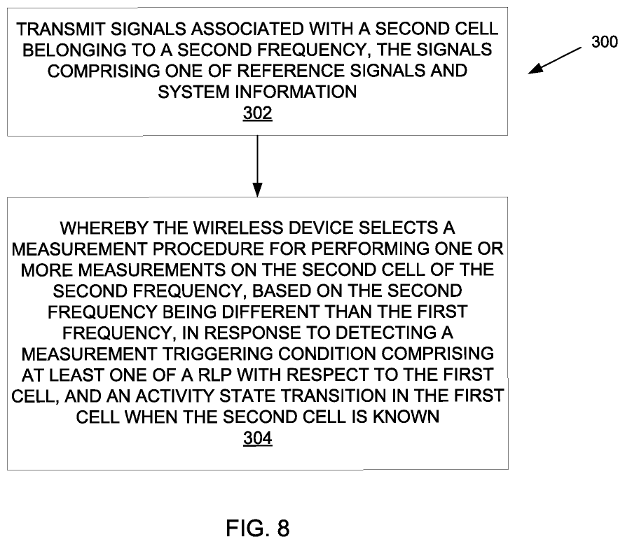

FIG. 8 depicts a method 300, performed by a second base station operative in a wireless communication network and serving a wireless device, for enabling the wireless device, served in a first cell by a first base station, to perform measurements for the wireless device to reestablish connection with the wireless communication network, in accordance with other particular embodiments. Signals associated with a second cell belonging to a second frequency are transmitted, the signals comprising one of reference signals and system information (block 202). The wireless device selects a measurement procedure for performing one or more measurements on the second cell of the second frequency, based on the second frequency being different than the first frequency, in response to detecting a measurement triggering condition comprising at least one of a RLP with respect to the first cell, and an activity state transition in the first cell when the second cell is known (block 204).

Note that the apparatuses described above may perform the methods 100, 200, 300 herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

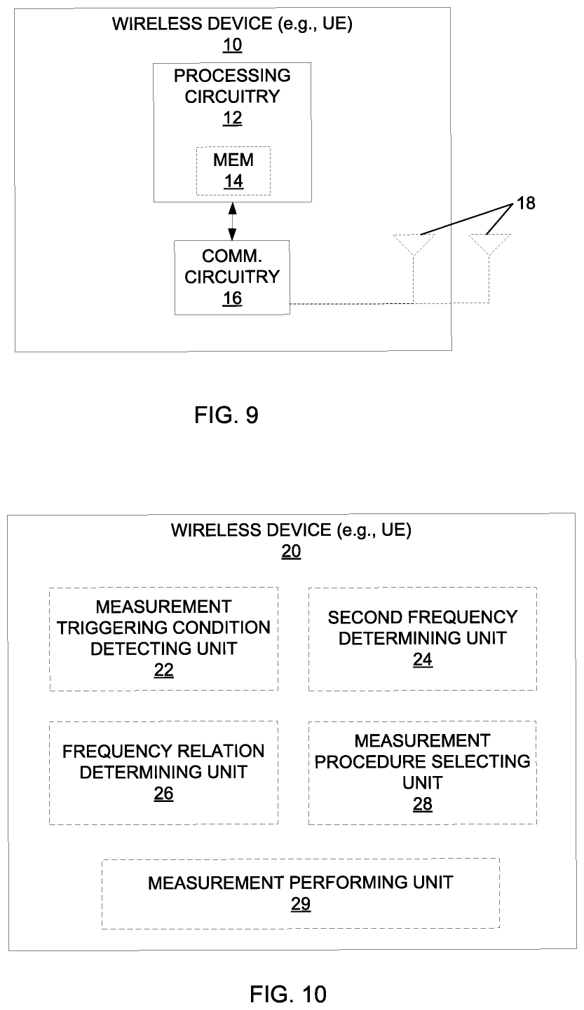

FIG. 9 for example illustrates a hardware block diagram of a wireless device 10 as implemented in accordance with one or more embodiments. As shown, the wireless device 10 includes processing circuitry 12 and communication circuitry 16. The communication circuitry 16 (e.g., radio circuitry) is configured to transmit and/or receive information to and/or from one or more other nodes, e.g., via any communication technology. Such communication may occur via one or more antennas 18 that may be either internal or external to the wireless device 10, as indicated by dashed lines. The processing circuitry 12 is configured to perform processing described above, such as by executing instructions stored in memory 14. The processing circuitry 12 in this regard may implement certain functional means, units, or modules.

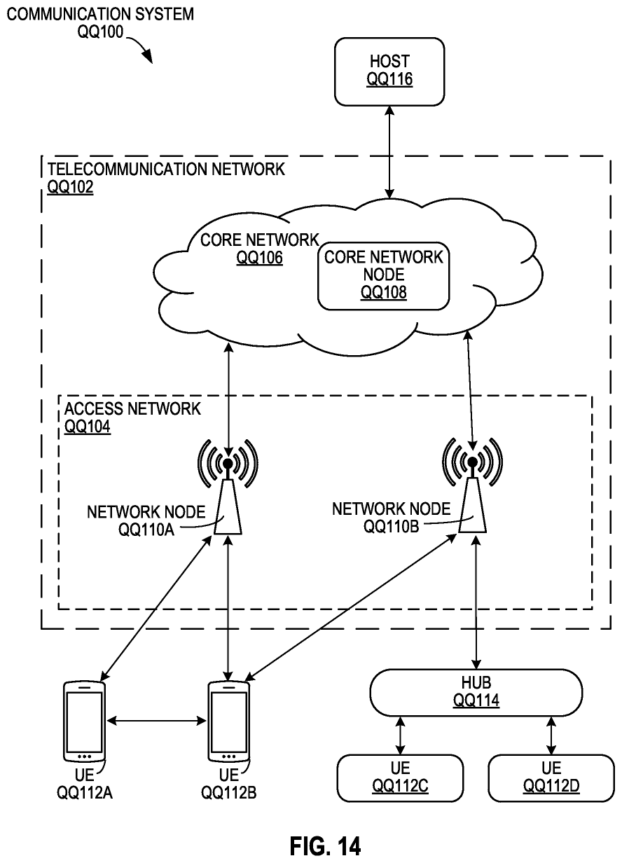

FIG. 10 illustrates a functional block diagram of a wireless device 20 in a wireless network according to still other embodiments (for example, the wireless network shown in FIG. 14). As shown, the wireless device 20 implements various functional means, units, or modules, e.g., via the processing circuitry 12 in FIG. 9 and/or via software code. These functional means, units, or modules, e.g., for implementing the method(s) herein, include for instance: measurement triggering condition detecting unit 22, second frequency determining unit 24, frequency relation determining unit 26, measurement procedure selecting unit 28, and measurement performing unit 29.

The measurement triggering condition detecting unit 22 is configured to detect a measurement triggering condition comprising at least one of a Radio Link Problem (RLP) with respect to a first cell belonging to a first frequency, and an activity state transition when a second cell is known. The second frequency determining unit 24 is configured to, in response to detecting the measurement triggering condition, determine a second frequency on which to perform measurements. The frequency relation determining unit 26 is configured to determine a frequency relation between the first and second frequencies. The measurement procedure selecting unit 28 is configured to select a measurement procedure for performing one or more measurements on at least one selected cell of the second frequency, based on the determined frequency relation between the first and second frequencies. The measurement performing unit 29 is configured to perform measurements on the second frequency according to the selected measurement procedure.

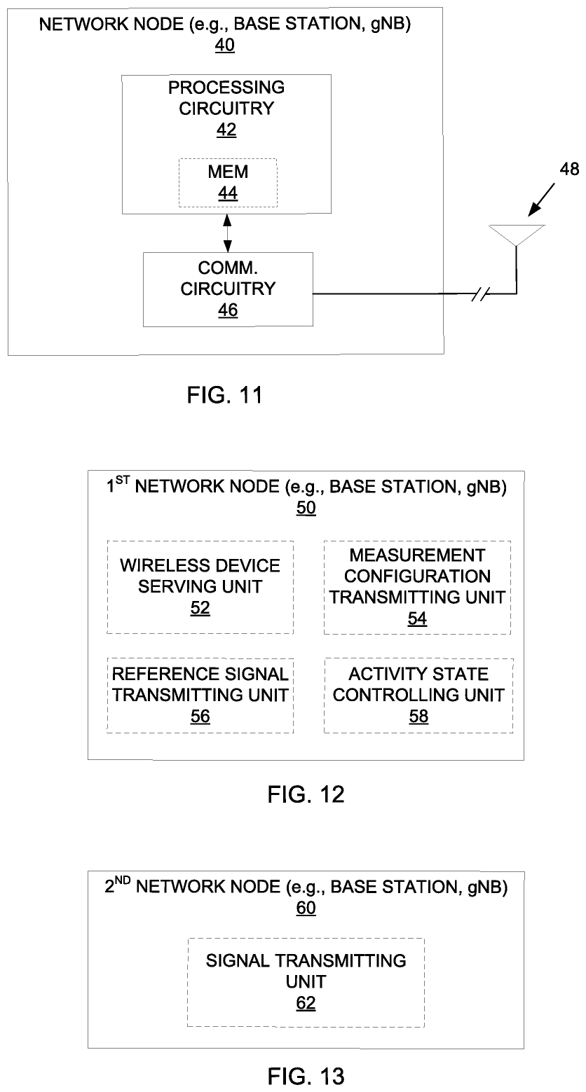

FIG. 11 illustrates a hardware block diagram of a network node 40 as implemented in accordance with one or more embodiments. The network node 40 implements base station functionality, e.g., a gNB in NR, and may comprise the first network node serving the wireless device 10 in the first cell, or the second network node serving the wireless device 10 in the second cell, as described herein. As shown, the network node 40 includes processing circuitry 42 and communication circuitry 46. The communication circuitry 46 is configured to transmit and/or receive information to and/or from one or more wireless devices 10 and/or other network nodes, e.g., via any communication technology. The communication circuitry 46 communicates with the wireless devices 10 wirelessly via one or more antennas 48. As indicated by the broken line, the antennas 48 may be located remotely from the network node 40, such as on a tower or building. The processing circuitry 42 is configured to perform processing described above, such as by executing instructions stored in memory 44. The processing circuitry 42 in this regard may implement certain functional means, units, or modules.

FIG. 12 illustrates a functional block diagram of a first network node 50 in a wireless network according to still other embodiments (for example, the wireless network shown in FIG. 14). The first network node 50 implements a first serving base station serving a wireless device 10 in a first cell belonging to a first frequency, as depicted in FIG. 4. As shown, the first network node 50 implements various functional means, units, or modules, e.g., via the processing circuitry 42 in FIG. 11 and/or via software code. These functional means, units, or modules, e.g., for implementing the method(s) herein, include for instance: wireless device serving unit 52, measurement configuration transmitting unit 54, reference signal transmitting unit 56, and activity state controlling unit 58.

The wireless device serving unit 52 is configured to serve the wireless device in a first cell belonging to a first frequency. The measurement configuration transmitting unit 54 is configured to transmit a measurement configuration to the wireless device, the measurement configuration identifying a second frequency on which the wireless device may perform measurements. The reference signal transmitting unit 56 is configured to transmit reference signals on the first frequency, whereby the wireless device can detect a Radio Link Problem (RLP) with respect to a first cell. The activity state controlling unit 58 is configured to transmit reference signals on the first frequency, whereby the wireless device can detect a Radio Link Problem (RLP) with respect to a first cell. The units 52, 54, 56, 58 enable the wireless device 10 to select a measurement procedure for performing one or more measurements on at least one selected cell of the second frequency, based on determining that the first and second frequencies are different, in response to detecting a measurement triggering condition comprising at least one of a RLP with respect to a first cell belonging to a first frequency, and an activity state transition when a second cell is known.

FIG. 13 illustrates a functional block diagram of a second network node 60 in a wireless network according to still other embodiments (for example, the wireless network shown in FIG. 14). The second network node 60 implements a serving base station serving a second cell belonging to a second frequency, as depicted in FIG. 4. As shown, the second network node 60 implements various functional means, units, or modules, e.g., via the processing circuitry 42 in FIG. 11 and/or via software code. These functional means, units, or modules, e.g., for implementing the method(s) herein, include for instance: signal transmitting unit 62.

The signal transmitting unit 62 is configured to transmit signals associated with a second cell belonging to a second frequency, the signals comprising one of reference signals and system information. The signal transmitting unit 62 enables the wireless device 10 to select a measurement procedure for performing one or more measurements on the second cell of the second frequency, based on determining that the first and second frequencies are different, in response to detecting a measurement triggering condition comprising at least one of a Radio Link Problem (RLP) with respect to the first cell, and an activity state transition in the first cell when the second cell is known.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

### Network Description and Over the Top (OTT) Implementations

FIG. 14 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access node or non-3GPP access point. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular in if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

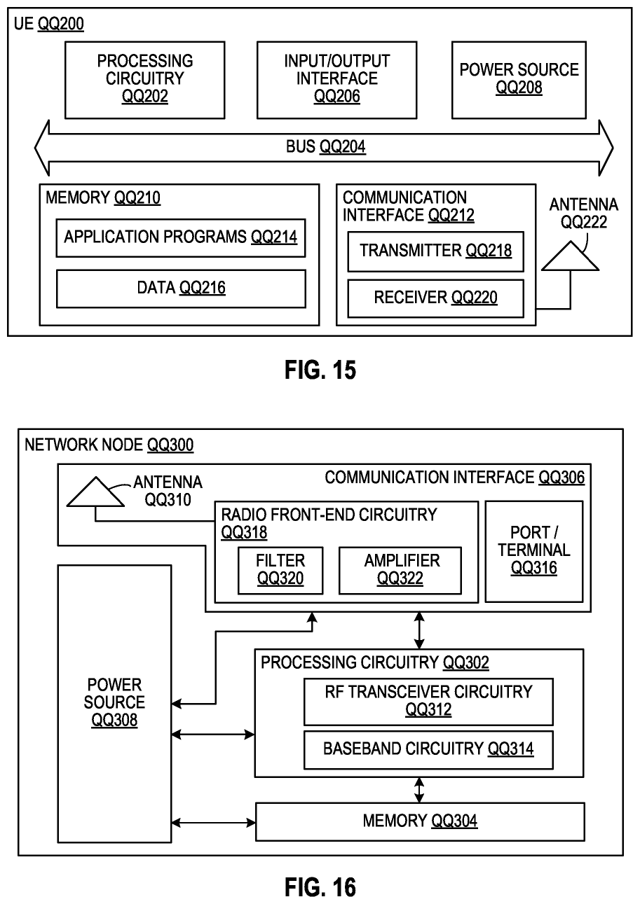

FIG. 15 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 16 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

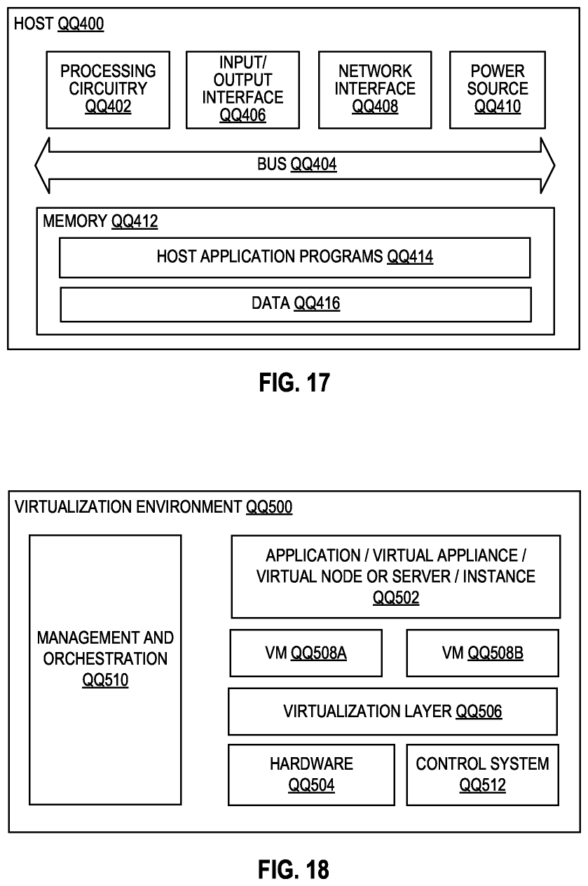

FIG. 17 is a block diagram of a host QQ400, which may be an embodiment of the host QQ116 of FIG. 14, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as Figures QQ2 and QQ3, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ512 which may alternatively be used for communication between hardware nodes and radio units.

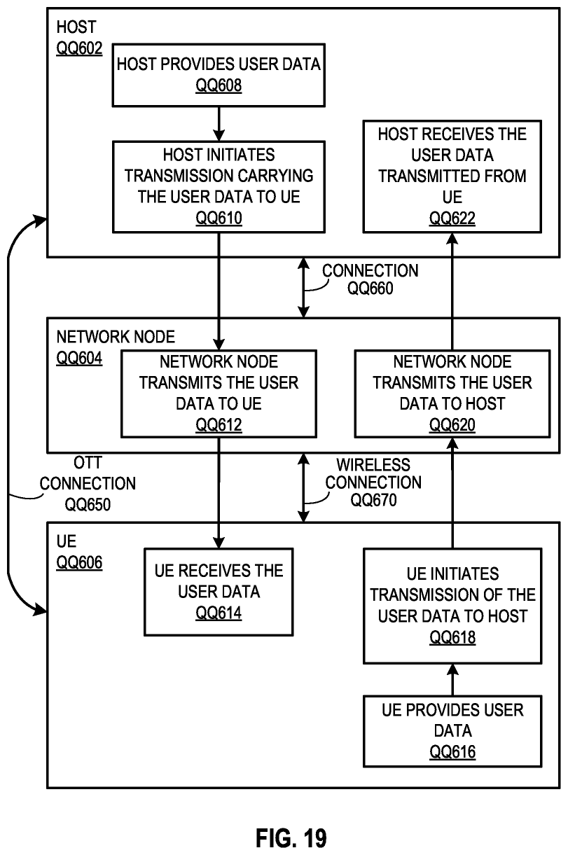

FIG. 19 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 14 and/or UE QQ200 of FIG. 15), network node (such as network node QQ110a of FIG. 14 and/or network node QQ300 of FIG. 16), and host (such as host QQ116 of FIG. 14 and/or host QQ400 of FIG. 17) discussed in the preceding paragraphs will now be described with reference to FIG. 19.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 14) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the network connection reestablishment of a wireless device and thereby provide benefits such as reduced errors due to missed signaling, faster response for wireless devices to reestablish connection, improved battery life, and reduced interference.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signaling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

### EMBODIMENTS

### Group A Embodiments

1. A method, performed by a wireless device, for performing measurements for reestablishing connection with a wireless communication network, the method comprising:
detecting a measurement triggering condition comprising at least one of a Radio Link Problem (RLP) with respect to a first cell belonging to a first frequency, and an activity state transition when a second cell is known;
in response to detecting the measurement triggering condition, determining a second frequency on which to perform measurements;
determining a frequency relation between the first and second frequencies;
selecting a measurement procedure for performing one or more measurements on at least one selected cell of the second frequency, based on the determined frequency relation between the first and second frequencies; and
performing measurements on the second frequency according to the selected measurement procedure.

2. The method of embodiment 1, further comprising using results of the measurement for one or more of: performing network connection re-establishment on the selected cell; acquiring system information of the selected cell; and informing a serving node of the selected cell that the wireless device has successfully performed the network connection re-establishment.

3. The method of embodiment 1 wherein detecting a Radio Link Problem (RLP) comprises detecting one or more of: a first predetermined number of out of synch (OOS) conditions, a second predetermined number of out of synch (OOS) conditions within a predetermined time period, an RLP timer running beyond a predetermined duration, receiving signals from a serving cell with a quality below a first predetermined threshold, receiving signals from a serving cell with a quality below the first predetermined threshold for a predetermined duration, and failure to decode a control channel from a serving cell.

4. The method of embodiment 1 wherein determining a second frequency on which to perform measurements comprises one of: receiving a measurement configuration from a serving cell identifying the second frequency; retrieving identification of the second frequency from memory from an earlier measurement configuration; determining the second frequency from historical data or past statistics related to measurements performed by the UE; and performing a frequency scan.

5. The method of embodiment 1 wherein determining a frequency relation between the first and second frequencies comprises determining whether the first and second frequencies are the same or different, based on one of: the frequencies' E-UTRA Absolute Radio Frequency Channel Number (EARFCN); the frequencies' center frequencies; and whether the frequencies are configured at the same raster points in the frequency domain.

6. The method of embodiment 1 wherein selecting a measurement procedure based on the frequency relation between the first and second frequencies comprises:
selecting an intra-frequency measurement procedure, in which the wireless device may measure on any time resource, if the first and second frequencies are the same; and
selecting an inter-frequency measurement procedure, in which the wireless device measures on a limited set of measurement occasions where reference signals are guaranteed to be available at the wireless device and the wireless device measures a number of samples and averages the samples over a measurement time period, if the first and second frequencies are different.

7. The method of embodiment 6 wherein selecting the inter-frequency measurement procedure comprises:
if the measurement triggering condition is based on the activity state transition, selecting a first variant of the intra-frequency measurement procedure;
if the measurement triggering condition is based on the RLP detection, selecting a second variant of the intra-frequency measurement procedure; and
if both measurement triggering conditions are true or become true, the selection of one of the first and second variants of the intra-frequency measurement procedure is based on a pre-defined or configured rule;
wherein the first and second variants of the intra-frequency measurement procedure differ in terms of one or more of their: measurement sampling rates; number of measurement samples; measurement periods over which the wireless device performs the measurement; and validity time or condition.

8. The method of embodiment 6 wherein selecting the first measurement procedure comprises:
if the measurement triggering condition is based on the activity state transition, selecting a first variant of the intra-frequency measurement procedure;
if the measurement triggering condition is based on the RLP detection, selecting a second variant of the intra-frequency measurement procedure; and
if both measurement triggering conditions are true or become true, the selection of one of the first and second variants of the intra-frequency measurement procedure is based on a pre-defined or configured rule;
wherein the first and second variants of the intra-frequency measurement procedure differ in terms of one or more of their: measurement sampling rates; number of measurement samples; measurement periods over which the wireless device performs the measurement; and validity time or condition.

9. The method of embodiment 1 wherein performing measurements on the second frequency according to the selected measurement procedure comprises one or more of: detecting a target cell on the second frequency using synchronization signals transmitted by the target cell; and performing signal power measurements using reference signals on the target cell after it has been detected.

10. The method of embodiment 1 wherein the activity state of the wireless device comprises one of: Radio Resource Control (RRC) Idle, RRC Inactive, or RRC Connected.

11. The method of any of the previous embodiments, further comprising:
providing user data; and
forwarding the user data to a host via the transmission to the network node.

### Group B Embodiments

12. A method, performed by a first base station operative in a wireless communication network and serving a wireless device, for enabling the wireless device to perform measurements for reestablishing connection with the wireless communication network, the method comprising:
serving the wireless device in a first cell belonging to a first frequency;
transmitting reference signals on the first frequency, whereby the wireless device can detect a Radio Link Problem (RLP) with respect to a first cell; and
controlling an activity state of the wireless device, whereby the wireless device can detect a transition in its activity state;
whereby the wireless device determines a second frequency on which to perform measurements, and selects a measurement procedure for performing one or more measurements on at least one selected cell of the second frequency, based on a determined frequency relation between the first and second frequencies, in response to detecting a measurement triggering condition comprising at least one of a Radio Link Problem (RLP) with respect to a first cell belonging to a first frequency, and an activity state transition when a second cell is known.

13. A method, performed by a second base station operative in a wireless communication network, for enabling the wireless device, served in a first cell by a first base station, to perform measurements for the wireless device to reestablish connection with the wireless communication network, the method comprising:
transmitting signals associated with a second cell belonging to a second frequency, the signals comprising one of reference signals and system information;
whereby the wireless device selects a measurement procedure for performing one or more measurements on the second cell of the second frequency, based on a determined frequency relation between the second frequency and a first frequency transmitted by the first base station, in response to detecting a measurement triggering condition comprising at least one of a Radio Link Problem (RLP) with respect to the first cell, and an activity state transition in the first cell when the second cell is known.

14. The method of any of the previous embodiments, further comprising:
obtaining user data; and
forwarding the user data to a host or a user equipment.

### Group C Embodiments

15. A user equipment for performing measurements for reestablishing connection with a wireless communication network, comprising:
processing circuitry configured to perform any of the steps of any of the Group A embodiments; and
power supply circuitry configured to supply power to the processing circuitry.

16. A network node for performing measurements for reestablishing connection with a wireless communication network, the network node comprising:
processing circuitry configured to perform any of the steps of any of the Group B embodiments; power supply circuitry configured to supply power to the processing circuitry.

17. A user equipment (UE) for performing measurements for reestablishing connection with a wireless communication network, the UE comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

18. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

19. The host of the previous embodiment, wherein the cellular network further includes a network node configured to communicate with the UE to transmit the user data to the UE from the host.

20. The host of the previous 2 embodiments, wherein:
the processing circuitry of the host is configured to execute a host application, thereby providing the user data; and
the host application is configured to interact with a client application executing on the UE, the client application being associated with the host application.

21. A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

22. The method of the previous embodiment, further comprising:
at the host, executing a host application associated with a client application executing on the UE to receive the user data from the UE.

23. The method of the previous embodiment, further comprising:
at the host, transmitting input data to the client application executing on the UE, the input data being provided by executing the host application,
wherein the user data is provided by the client application in response to the input data from the host application.

24. A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

25. The host of the previous embodiment, wherein the cellular network further includes a network node configured to communicate with the UE to transmit the user data from the UE to the host.

26. The host of the previous 2 embodiments, wherein:
the processing circuitry of the host is configured to execute a host application, thereby providing the user data; and
the host application is configured to interact with a client application executing on the UE, the client application being associated with the host application.

27. A method implemented by a host configured to operate in a communication system that further includes a network node and a user equipment (UE), the method comprising:
at the host, receiving user data transmitted to the host via the network node by the UE, wherein the UE performs any of the steps of any of the Group A embodiments to transmit the user data to the host.

28. The method of the previous embodiment, further comprising:
at the host, executing a host application associated with a client application executing on the UE to receive the user data from the UE.

29. The method of the previous embodiment, further comprising:
at the host, transmitting input data to the client application executing on the UE, the input data being provided by executing the host application,
wherein the user data is provided by the client application in response to the input data from the host application.

30. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

31. The host of the previous embodiment, wherein:
the processing circuitry of the host is configured to execute a host application that provides the user data; and
the UE comprises processing circuitry configured to execute a client application associated with the host application to receive the transmission of user data from the host.

32. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

33. The method of the previous embodiment, further comprising, at the network node, transmitting the user data provided by the host for the UE.

34. The method of any of the previous 2 embodiments, wherein the user data is provided at the host by executing a host application that interacts with a client application executing on the UE, the client application being associated with the host application.

35. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

36. The communication system of the previous embodiment, further comprising:
the network node; and/or
the user equipment.

37. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

38. The host of the previous 2 embodiments, wherein:
the processing circuitry of the host is configured to execute a host application, thereby providing the user data; and
the host application is configured to interact with a client application executing on the UE, the client application being associated with the host application.

39. The host of the any of the previous 2 embodiments, wherein the initiating receipt of the user data comprises requesting the user data.

40. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs any of the steps of any of the Group B embodiments to receive the user data from the UE for the host.

41. The method of the previous embodiment, further comprising at the network node, transmitting the received user data to the host.

Embodiments of the present invention present numerous advantages over the prior art. The UE neighbor cell measurement behavior in RRC connected state is well defined leading to consistent measurement results. The time to perform RRC connection re-establishment upon RLF is reduced. The UE neighbor cell measurement for RRC re-establishment can be done on any type of carrier without measurement gaps, e.g., on anchor, non-anchor, or inter-frequency carriers, etc. Embodiments provide the UE the ability to also select cells in a different frequency (inter-frequency) based upon measurements upon RLF.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-70. (canceled)

71. A method, performed by a wireless device, for performing measurements for reestablishing connection with a wireless communication network, the method comprising:
detecting a measurement triggering condition with regard to a Radio Link Problem, RLP, with respect to a serving cell belonging to a first frequency;
in response to a detected the measurement triggering condition, determining a second frequency of a second cell on which to perform measurements, wherein the second frequency is different from the first frequency; and
performing measurements on the second frequency attempting for network connection re-establishment on the second cell.

72. The method of claim 71, wherein detecting a RLP comprises receiving signals from the serving cell with a Narrowband Reference Signal Received Quality, NRSRQ, below a first predetermined threshold.

73. The method of claim 72, wherein detecting a RLP comprises receiving signals from the serving cell with a NRSRQ below the first predetermined threshold for a predetermined duration.

74. The method of claim 71, wherein determining a second frequency on which to perform measurements is based on a measurement configuration identifying the second frequency received from the serving cell.

75. The method of claim 71, wherein performing measurements on the second frequency comprises: measuring a number of samples over a measurement time period, wherein the measurement time period is given by
Tm=f(α,Ns,Tmax,Taⱼ) where
f( ) denotes a function;
α is an implementation margin;
Ns is a number of samples or snapshots required for performing a particular measurement;
Tmax is a maximum time interval allowed between two successive measurement occasions for performing valid measurement; and
Taⱼ is the time interval between two successive measurement occasions available for measurement sample j obtained for the measurements.

76. The method of claim 75 wherein Taj varies between Tmin and Tmax, where Tmin is a minimum time interval between two successive measurement occasions for performing valid measurement.

77. The method of claim 76, wherein Tmax and/or Tmin is different for different type of measurement samples.

78. The method of claim 75, wherein the value of Ns depends on the type of measurement being performed.

79. The method of claim 76, wherein α is 0, Tmin, or a constant larger than 0.

80. The method of claim 75, wherein the measurement time period is given by
$$Tm = α + {\sum }_{k = 1}^{Ns} MIN ( T max , {Ta}_{j} ) .$$

81. The method of claim 75, wherein each of Ns measurement samples is obtained in a measurement occasion during the measurement time period Tm, and wherein the measurement result is obtained by performing a resolving function on the Ns measurement samples.

82. The method of claim 81, wherein the resolving function comprises one of: averaging the values, maximum value, maximum absolute value, and product of the Ns measurement samples.

83. The method of claim 78, wherein the type of measurement being performed is NRS based NRSRP measurement, NSSS based NRSRP measurement, or NPSS based NRSRP measurement.

84. A wireless device, operative in a wireless communication network, comprising:
communication circuitry;
processing circuitry operatively connected to the communication circuitry and configured to:
detect a measurement triggering condition with regard to a Radio Link Problem, RLP, with respect to a serving cell belonging to a first frequency;
in response to a detected the measurement triggering condition, determine a second frequency of a second cell on which to perform measurements, wherein the second frequency is different from the first frequency; and
perform measurements on the second frequency attempting for network connection re-establishment on the second cell.

85. A method, performed by a first base station operative in a wireless communication network and serving a wireless device in a first cell belonging to a first frequency, for enabling the wireless device to perform measurements for reestablishing connection with the wireless communication network, the method comprising:
transmitting a measurement configuration to the wireless device, the measurement configuration identifying a second frequency on which the wireless device may perform measurements, wherein the second frequency is different from the first frequency; and
transmitting reference signals on the first frequency, whereby the wireless device can detect a Radio Link Problem with respect to a first cell.
